(19) United States
(12) Patent Application Publication
(10) Pub. No.: US 2002/0144109 A1
(43) Pub. Date: Oct. 3, 2002

(54) Method and system for facilitating public key credentials acquisition

(75) Inventors: Messaoud Benantar, Austin, TX (US); Anthony Joseph Nadalin, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, Armonk, NY (US)

(21) Appl. No.: 09/821,081

(22) Filed: Mar. 29, 2001

(51) Int. Cl. H04L 9/00

(52) U.S. Cl. 713/156

(57) ABSTRACT

A methodology is presented for securely acquiring and managing PKI credentials using an enterprise's pre-existing information technology. A management application places user information from a directory into a pre-registration record, which is sent to the user as an e-mail attachment. When the user views the e-mail message through a browser-type application that has built-in key generation and digital certificate management, the user may be prompted for additional information, such as passwords. The browser-type application then generates a public/private key pair and stores the private key in a secure local keystore while also securely sending the public key, authentication data, and pre-registration record to a registration/certificate authority. A public key certificate and an attribute certificate are then issued for the user, copies of which are published into the directory and returned to the user for storing within the user's secure local keystore. The certificates may then be used in typical manners.

### BACKGROUND OF THE INVENTION

1. Field of the Invention

The present invention relates to an improved data processing system and, in particular, to a method and apparatus for a cryptographic methodology. Still more particularly, the present invention provides a method and apparatus for cryptographic key management.

2. Description of Related Art

Commercial use of the Internet is increasing dramatically. Web-based and Internet-based applications have now become so commonplace that when one learns of a new product or service, one assumes that the product or service will incorporate Internet functionality into the product or service. New applications that incorporate significant proprietary technology are only developed when an enterprise has a significantly compelling reason for doing so. Many corporations have employed proprietary data services for many years, but it is now commonplace to assume that individuals and small enterprises also have access to digital communication services. Many of these services are or will be Internet-based, and the amount of electronic communication on the Internet is growing exponentially.

One of the factors influencing the growth of the Internet is the adherence to open standards for much of the Internet infrastructure. Individuals, public institutions, and commercial enterprises alike are able to introduce new content, products, and services that are quickly integrated into the digital infrastructure because of their ability to exploit common knowledge of open standards.

Concerns about the integrity and privacy of electronic communication have also grown with adoption of Internet-based services. Various encryption and authentication technologies have been developed to protect electronic communication. For example, an open standard promulgated for protecting electronic communication is the X.509 standard for digital certificates.

An X.509 digital certificate is an International Telecommunications Union (ITU) standard that has been adopted by the Internet Engineering Task Force (IETF) body. It cryptographically binds the certificate holder, presumably the subject name within the certificate, with its public cryptographic key. This cryptographic binding is based on the involvement of a trusted entity in the Public Key Infrastructure (PKI) called the “Certifying Authority”. As a result, a strong and trusted association between the certificate holder and its public key can become public information yet remain tamper-proof and reliable. An important aspect of this reliability is a digital signature that the Certifying Authority stamps on a certificate before it is released for use. Subsequently, whenever the certificate is presented to a system for use of a service, its signature is verified before the subject holder is authenticated. After the authentication process is successfully completed, the certificate holder may be provided access to certain information, services, or controlled resources, i.e. the certificate holder may be authorized to access certain systems.

A standard for an X.509 Attribute Certificate has been proposed by which attribute certificates would be similar in structure to public key certificates but in which the attribute certificate would not contain a public key. An attribute certificate would be used to certify or otherwise securely bind a set of authorization capabilities to its subject holder. Those capabilities are possibly authenticated and then cryptographically verified by a target service sought by the holder of the attribute certificate, and the attribute certificate may then be used for enabling access to controlled resources.

Although PKI technology provides robust standards for secure communication, PKI technology has been adopted slowly. One reason for the slow deployment of PKI is the complexity of PKI management, including the initial stage of obtaining any necessary PKI-related data items. Ideally, a PKI user should not be required to perform a series of tasks through multiple applications in order to acquire PKI credentials, such as certificates and private keys.

Therefore, it would be advantageous to have a method and system for seamlessly integrating the acquisition of PKI credentials into other user management activities. It would be particularly advantageous to facilitate PKI acquisition into other user enrollment or initialization procedures within an enterprise.

### SUMMARY OF THE INVENTION

A method, a system, an apparatus, and a computer program product are presented for facilitating PKI credential acquisition and management. PKI credentials are securely acquired and stored for subsequent use by users within an enterprise while using an enterprise's pre-existing information technology, such as directories, mail systems, and installed applications.

In order to register a user with a registration authority such that the user may be issued any needed PKI credentials, a user management application retrieves user information from a directory and places the user information into a pre-registration record, which may be signed by the management application to authenticate that a credential request contains authenticate user information from a trusted enterprise application/authority. The pre-registration record is subsequently sent to the user as an e-mail attachment.

The user then views the e-mail message through a Internet-client application or browser-type application that has built-in key generation functionality and built-in key/digital certificate management functionality, which are common features for this type of application. The e-mail message may prompt the user for additional personal or enterprise-specific information, such as passwords for applications within the enterprise. The browser-type application then generates a public/private key pair and securely stores the private key in a secure local keystore while also securely sending the public key, authentication data, and pre-registration record to a registration/certificate authority. A public key certificate and an attribute certificate are then issued for the user. A copy of each certificate is published into the enterprise's directory in association with the user's other information within the directory, and a copy of each certificate is returned to the user for storing within the user's secure local keystore.

The certificates may then be used in typical manners. For example, other entities may send secure communications to the user by obtaining the user's public key from the user's public key certificate after retrieving the public key certificate from the directory. The user may also present the certificates to the appropriate entities during secure transactions.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 depicts a typical manner in which an entity obtains a digital certificate;

FIG. 3A is a block diagram depicting a typical manner in which an entity may use a digital certificate to be authenticated to an Internet system or application;

FIG. 3B is a block diagram depicting a typical manner in which an entity may use a digital certificate and an accompanying attribute certificate to be authenticated and authorized to an Internet system or application in order to be granted access to controlled resources;

FIG. 4 is a block diagram depicting the information flow among some of the components that may be used to acquire and store a set of user PKI credentials, such as a public key certificate, an accompanying attribute certificate, and a private key in accordance with a preferred embodiment of the present invention; and

FIGS. 5A-5B are flowcharts depicting the processes that are performed by a management application and a user's browser while acquiring and storing the user's PKI credentials in accordance with a preferred embodiment of the present invention.

### DETAILED DESCRIPTION OF THE INVENTION

The present invention provides a process and a system for PKI credential acquisition and management. As background, a typical organization of hardware and software components within a distributed data processing system is described prior to describing the present invention in more detail.

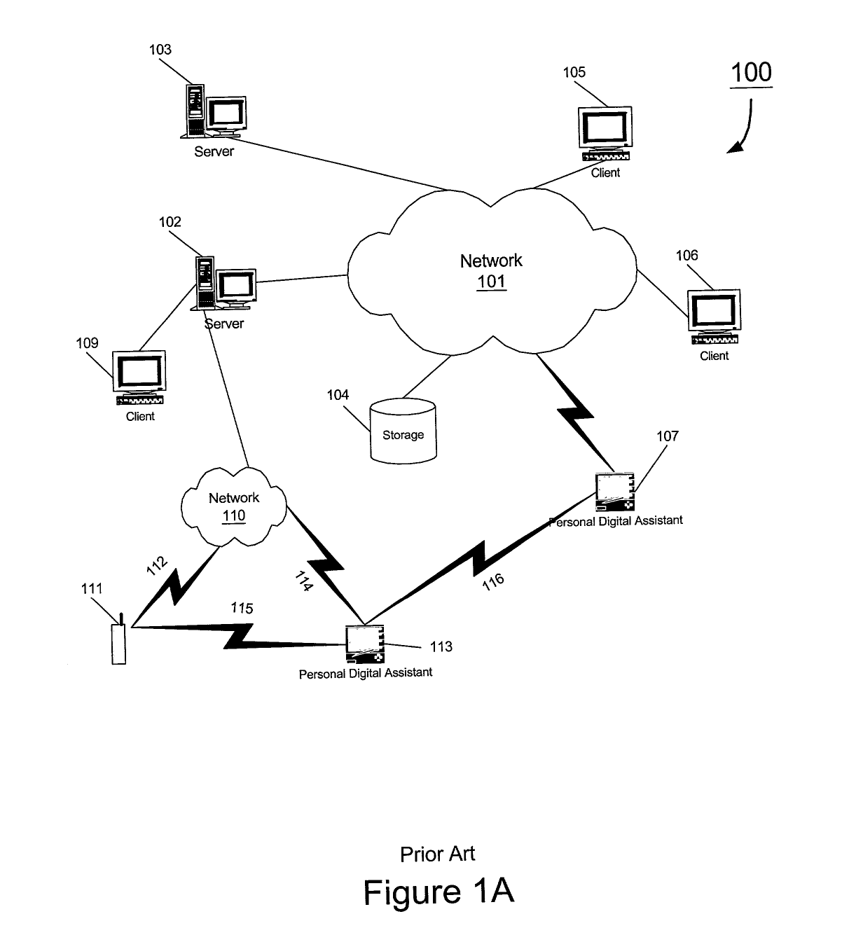

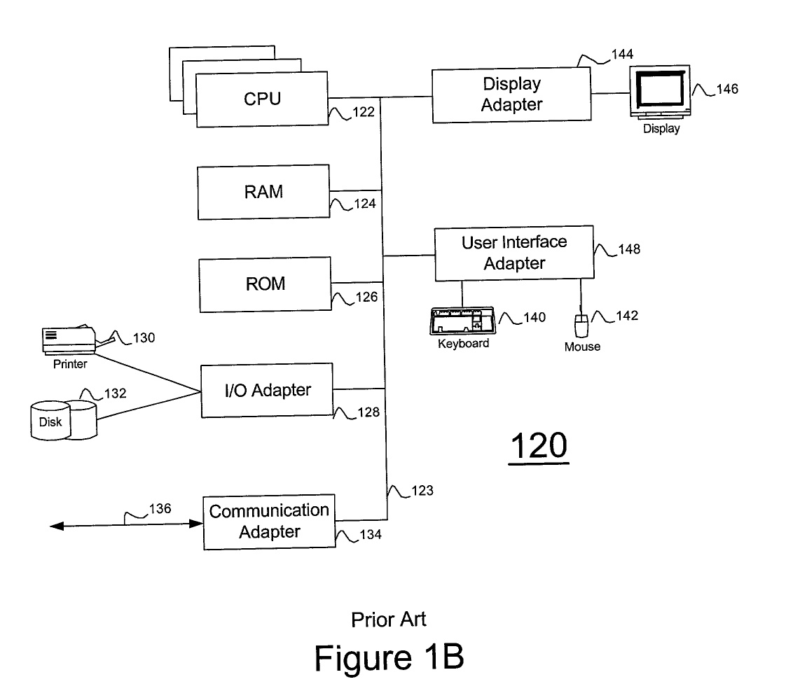

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention. Hence, it should be noted that the distributed data processing system shown in FIG. 1A is contemplated as being fully able to support a variety of peer-to-peer subnets and peer-to-peer services.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find similar components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include an Internet client application, e.g., an Internet/Web browser or microbrowser. These types of applications are well known software applications for accessing Internet or Web-based information and documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above. More specifically, though, the present invention is directed to a methodology for acquiring and managing cryptographic keys and digital certificates. To accomplish this goal, the present invention uses known applications in a novel manner to obtain and store these PKI credentials. Before describing the present invention in more detail, though, some background information about digital certificates is provided for evaluating the operational efficiencies and other advantages of the present invention.

Digital certificates support public key cryptography in which each party involved in a communication or transaction has a pair of keys, called the public key and the private key. Each party's public key is published while the private key is kept secret. Public keys are numbers associated with a particular entity and are intended to be known to everyone who needs to have trusted interactions with that entity. Private keys are numbers that are supposed to be known only to a particular entity, i.e. kept secret. In a typical public key cryptographic system, a private key corresponds to exactly one public key.

Within a public key cryptography system, since all communications involve only public keys and no private key is ever transmitted or shared, confidential messages can be generated using only public information and can be decrypted using only a private key that is in the sole possession of the intended recipient. Furthermore, public key cryptography can be used for authentication, i.e. digital signatures, as well as for privacy, i.e. encryption.

Encryption is the transformation of data into a form unreadable by anyone without a secret decryption key; encryption ensures privacy by keeping the content of the information hidden from anyone for whom it is not intended, even those who can see the encrypted data. Authentication is a process whereby the receiver of a digital message can be confident of the identity of the sender and/or the integrity of the message.

For example, when a sender encrypts a message, the public key of the receiver is used to transform the data within the original message into the contents of the encrypted message. A sender uses a public key to encrypt data, and the receiver uses a private key to decrypt the encrypted message.

When authenticating data, data can be signed by computing a digital signature from the data and the private key of the signer. Once the data is digitally signed, it can be stored with the identity of the signer and the signature that proves that the data originated from the signer. A signer uses a private key to sign data, and a receiver uses the public key to verify the signature. The present invention is directed to a form of using digital certificates; some encryption is also performed during the processing within the present invention.

A certificate is a digital document that vouches for the identity and key ownership of entities, such as an individual, a computer system, a specific server running on that system, etc. Certificates are issued by certificate authorities, possibly in conjunction with a registration authority. A certificate authority (CA) is an entity, usually a trusted third party to a transaction, that is trusted to sign or issue certificates for other people or entities. The CA usually has some kind of legal responsibilities for its vouching of the binding between a public key and its owner that allow one to trust the entity that signed a certificate. There are many such certificate authorities, such as VeriSign, Entrust, etc. These authorities are responsible for verifying the identity and key ownership of an entity when issuing the certificate.

If a certificate authority issues a certificate for an entity, the entity must provide a public key and some information about the entity. A software tool, such as a Web browser, may digitally sign this information and send it to the certificate authority. In some instances, the duty of ensuring the authenticity of these initial credentials are sometimes delegated to a registration authority (RA), while the duty of issuing the certificate is delegated to the certificate authority. The certificate authority might be a company like VeriSign that provides trusted third-party certificate authority services. The certificate authority will then generate the certificate and return it. The certificate may contain other information, such as dates during which the certificate is valid and a serial number. One part of the value provided by a certificate authority is to serve as a neutral and trusted introduction service, based in part on their verification requirements, which are openly published in their Certification Service Practices (CSP).

Typically, after the CA has received a request for a new digital certificate, which contains the requesting entity's public key, the CA signs the requesting entity's public key with the CA's private key and places the signed public key within the digital certificate. Anyone who receives the digital certificate during a transaction or communication can then use the public key of the CA to verify the signed public key within the certificate. The intention is that an entity's certificate verifies that the entity owns a particular public key.

The X.509 standard is one of many standards that defines the information within a certificate and describes the data format of that information. The “version” field indicates the X.509 version of the certificate format with provision for future versions of the standard. This identifies which version of the X.509 standard applies to this certificate, which affects what information can be specified in it. Thus far, three versions are defined. Version 1 of the X.509; standard for public key certificates was ratified in 1988. The version 2 standard, ratified in 1993, contained only minor enhancements to the version 1 standard. Version 3, defined in 1996, allows for flexible extensions to certificates in which certificates can be extended in a standardized and generic fashion to include additional information.

In addition to the traditional fields in public key certificates, i.e. those defined in versions 1 and 2 of X.509, version 3 comprises extensions referred to as “standard extensions”. The term “standard extensions” refers to the fact that the version 3 of the X.509 standard defines some broadly applicable extensions to the version 2 certificate. However, certificates are not constrained to only the standard extensions, and anyone can register an extension with the appropriate authorities. The extension mechanism itself is completely generic.

Other aspects of certificate processing are also standardized. The Certificate Request Message Format (RFC 2511) specifies a format recommended for use whenever a relying party is requesting a certificate from a CA. Certificate Management Protocols have also been promulgated for transferring certificates. More information about the X.509 public key infrastructure (PKIX) can be obtained from the Internet Engineering Task Force (IETF) at www.ietf.org.

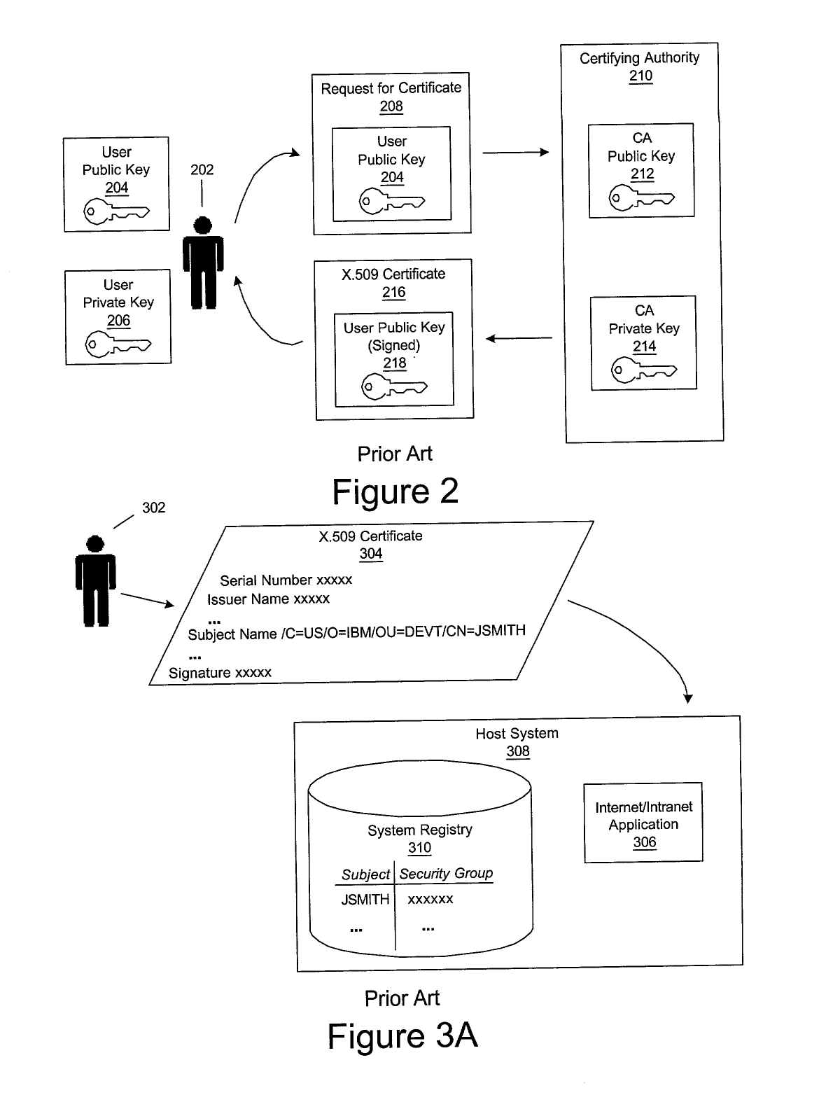

With reference now to FIG. 2, a block diagram depicts a typical manner in which an individual obtains a digital certificate. User 202, operating on some type of client computer, has previously obtained or generated a public/private key pair, e.g., user public key 204 and user private key 206. User 202 generates a request for certificate 208 containing user public key 204 and sends the request to certifying authority 210, which is in possession of CA public key 212 and CA private key 214. Certifying authority 210 verifies the identity of user 202 in some manner and generates X.509 digital certificate 216 containing signed user public key 218 that was signed with CA private key 214. User 202 receives newly generated digital certificate 216, and user 202 may then publish digital certificate 216 as necessary, e.g., into an LDAP directory, to engage in trusted transactions or trusted communications. An entity that receives digital certificate 216 may verify the signature of the CA by using CA public key 212, which is published and available to the verifying entity.

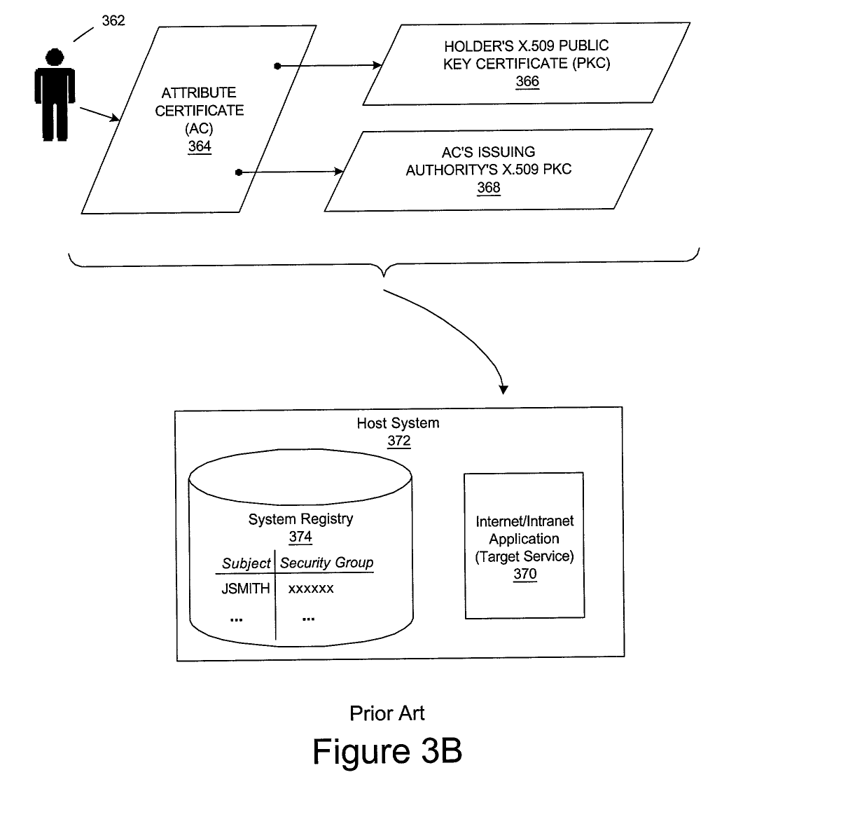

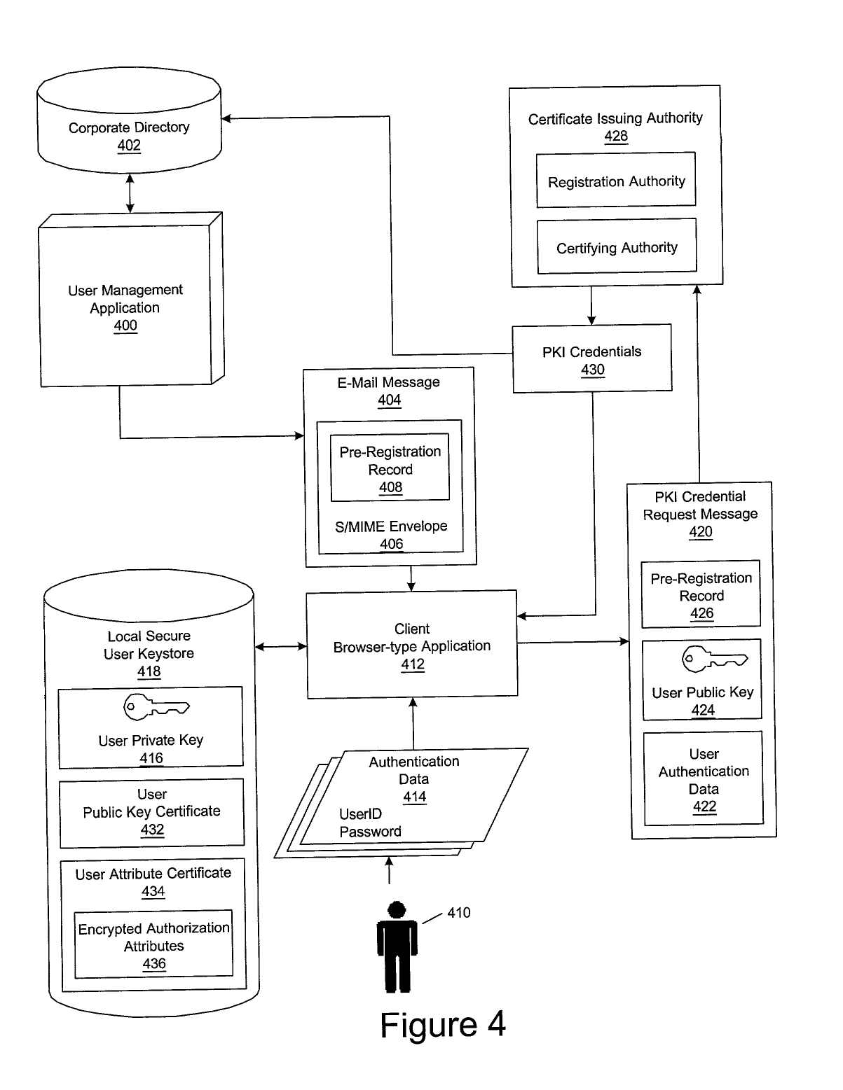

With reference now to FIG. 3A, a block diagram depicts a typical manner in which an entity may use a digital certificate to be authenticated to an Internet system or application. User 302 possesses X.509 digital certificate 304, which is transmitted to an Internet or intranet application 306 that comprises X.509 functionality for processing and using digital certificates and that operates on host system 308. The entity that receives certificate 304 may be an application, a system, a subsystem, etc. Certificate 304 contains a subject name or subject identifier that identifies user 302 to application 306, which may perform some type of service for user 302.

Host system 308 may also contain system registry 310 which is used to authorize user 302 for accessing services and resources within system 308, i.e. to reconcile a user's identity with user privileges. For example, a system administrator may have configured a user's identity to belong to certain a security group, and the user is restricted to being able to access only those resources that are configured to be available to the security group as a whole. Various well-known methods for imposing an authorization scheme may be employed within the system.

In order to facilitate the separation of authentication functions and authorization functions, a standard for an X.509 Attribute Certificate (AC) has been proposed by which attribute certificates (ACs) would be similar in structure to public key certificates (PKCs) but in which the attribute certificate would not contain a public key. An attribute certificate would be used to certify or otherwise securely bind a set of authorization capabilities to its subject holder. Those capabilities are preferably authenticated and then cryptographically verified by a target service sought by the holder of the attribute certificate, and the attribute certificate may then be used for enabling access to controlled resources.

A common analogy using passports and visas has been widely disseminated to explain the differences between public key certificates and attribute certificates. A public key certificate can be analogized to a passport: each identify the holder of the document; each have relatively long validity periods; and each require significant effort to obtain a valid document.

In contrast, an attribute certificate can be analogized to a visa. A visa is used to gain access somewhere in a manner similar to using an attribute certificate to gain access to a system. In addition, a visa must be accompanied by a passport that verifies/authenticates the identity of the holder of the passport and the visa. Similarly, an attribute certificate must be accompanied by a public key certificate to verify/authenticate the identity of the user. A visa is issued by an authority other than the authority that issues a passport, which is similar to an attribute certificate being issued by an authority different from the authority that issues the public key certificate. A visa and an attribute certificate have shorter validity periods than a passport or a public key certificate.

Public key certificates can provide an identity for controlled access purposes. However, merely proving one's identity does not provide one with access to a controlled resource. Instead, a role or group-membership is used; if the user can prove one's identity and that the identity has been previously associated with a role or a group membership, then one may gain access to a controlled resource.

Although it is possible to do so, placing authorization information in a public key extension can be problematic. For example, a user may have a valid identity for a relatively long period of time, but the user's authorized access privileges may change over time with each authorization period being shorter than the valid period of time for the user's identity. If one were to place the authorization information in a public key extension, then the public key certificate would have to be reissued when the user's privileges change, which would cause a significant administrative burden.

In other words, the concept of an X.509 Attribute Certificate, to which an X.509 V3 Public Key Certificate is a fundamental aspect, seeks to certify or securely bind a set of authorization capabilities to a subject in the same manner that an X.509 public key certificate binds a public key to that subject. The rationale behind the distinction between these two types of certificates is dictated by the dynamic nature of authorization roles that a particular entity can assume over a period of time while in possession of the same public key certificate.

Another problem, as was noted above, is that the authority that issues the public key certificate to verify the identity of a person is usually not the same authority that desires to authorize that person for use of particular systems. In fact, a preferred scheme would have relatively few public key certifying authorities on which many other institutions rely while these other institutions determine the authorization parameters for each individual institution. If the authorization information is placed into a public key extension, then the public key certifying authority must obtain authorization information from each institution to which the user desires to present the public key certificate, which is very difficult administratively.

Hence, it has been recognized that the public key infrastructure would be better served by separating authorization information from authentication information. However, authorization information must still be bound to a holder's identity to be useful.

In order to facilitate such a scheme, an attribute certificate provides a binding between a certificate holder and a set of attributes; the attribute certificate is a digitally signed (or certified) identity and set of attributes. After acquiring an attribute certificate, a user may present the attribute certificate in an attempt to gain access to a controlled resource. When a decision must be made concerning whether a user should have access to the controlled resource, the deciding authority needs to verify the identity of the holder of the attribute certificate.

Hence, an attribute certificate is generally proffered along with a public key certificate to access various security services, access controlled services, authentication services, etc. The attribute certificate contains some type of information that links the attribute certificate with a public key certificate, and the public key certificate is used for authentication purposes in conjunction with a request to access the controlled resource.

With reference now to FIG. 3B, a block diagram depicts a typical manner in which an entity may use an attribute certificate and its associated public key certificates to be authenticated and authorized to an Internet system or application in order to be granted access to controlled resources. User 362 possesses X.509 attribute certificate 364. User 362 sends attribute certificate 364, along with the user's associated PKC 366 and PKC 368 of the issuing authority for the user's attribute certificate, to Internet/intranet application (target service) 370 that comprises X.509 functionality and that operates on host system 372. As noted previously, an attribute certificate may contain attributes that specify group membership, role, security clearance, or other authorization information associated with the holder of the attribute certificate. Host system 372 may also contain system registry 374 that allows user 362 to access services and resources within system 370 as specified by information within attribute certificate 364.

As should be apparent from the description above, there is significant complexity to the acquisition and the use of digital certificates and cryptographic keys. The present invention is directed to facilitating PKI credential acquisition and management; PKI credentials are securely acquired and stored for subsequent use by users within an enterprise while using an enterprise's pre-existing information technology, such as directories, mail systems, and installed applications. The present invention is described in more detail with respect to the remaining figures.

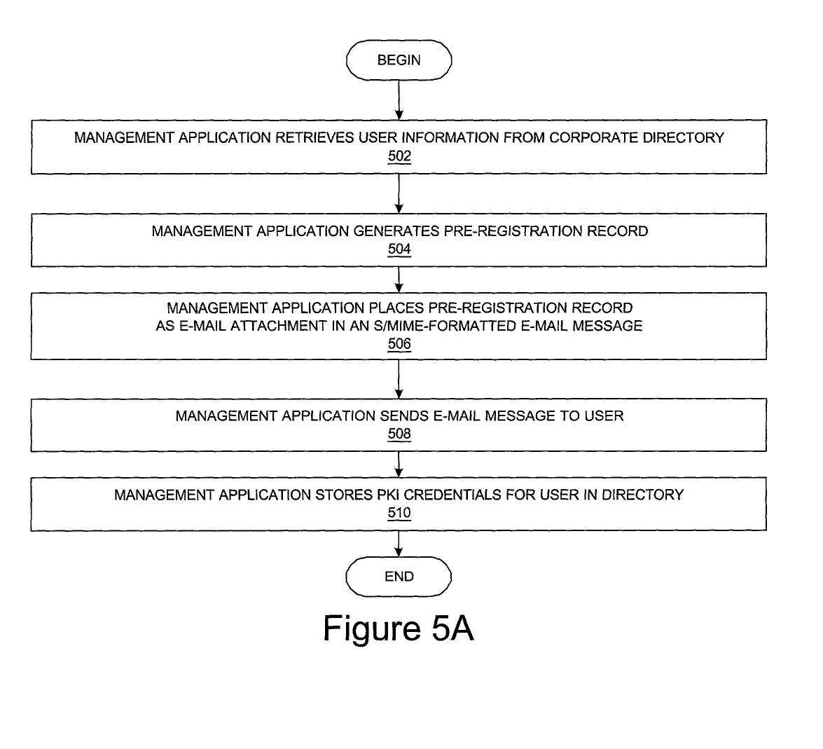

With reference now to FIG. 4, a block diagram depicts the information flow among some of the components that may be used to acquire and store a set of user PKI credentials, such as a public key certificate, an accompanying attribute certificate, and a private key in accordance with a preferred embodiment of the present invention. In summary, an application with responsibility for managing user accounts, which may be referred to as a system administration application, a user management application, or simply a management application, within some type of organization or service attempts to acquire a set of PKI credentials for a particular use.

The following examples show the processing that might occur within a corporation that is setting up a user with necessary information technology resources for accomplishing various computer-related tasks within the corporation, so-called “enrollment” processes. However, the following examples assume that a minimum amount of initialization or configuration has been previously accomplished for the user. For example, it is assumed that the user already has an entry within a directory, an e-mail account, etc. In other words, the following examples describe only some of the steps that would be used to configure a data processing system for a user. On the other hand, the following description shows the manner in which PKI credential acquisition can be seamlessly integrated with other user configuration tasks.

For example, within a given corporation, a new employee may be received by a human resources department on a first day of employment. Typically, the human resources department either contacts an IT department or uses software applications provided by an IT department to ensure that the user is accommodated within the corporation's data processing systems. Depending on the department to which the employee is assigned, the employee's job title and/or tasks, etc., the employee should receive access to various computational resources. For example, every employee might receive at least a corporate e-mail account, but other employees might obtain basic network privileges, while yet other employees receive access to more sophisticated protected resources. These employees should receive accounts and identities as required to perform the employee's duties within the corporation. Hence, an appropriate trusted party within the corporation, such as a human resources employee, uses its trusted identity to perform certain tasks to configure various systems for the new employee.

The present invention assumes that some of these types of tasks have already been accomplished through the appropriate management application or applications. Moreover, a person within the corporation with the appropriate authority has also used a management application to initiate the processing to be performed by the present invention to acquire digital authentication and authorization credentials for the new employee, or it has been automatically initiated in conjunction with other tasks. More importantly, the methodology of the present invention facilitates the complex task of PKI credential acquisition and management by seamlessly integrating and performing the PKI-related tasks in conjunction with other tasks, such as creating an entry within a directory for the new employee and creating an e-mail account for the new user, as will be apparent with reference to FIG. 4.

It should be noted that the following examples discuss a “new user”, but the examples apply to anyone who needs a set of PKI credentials.

In order to register a user with a registration authority such that the user may be issued any needed PKI credentials, management application 400 retrieves user information from directory 402. For example, the directory may be an enterprise-wide directory containing information about all employees, including the X.500 distinguished name assigned to the new user, the new user's e-mail address, and the new user's authorized privileges for protected resources. Management application 400 uses the user information to construct a PKI pre-registration record that is appropriate for the PKI credentials that the new user requires. In most cases, the PKI credentials would include a public key certificate and an attribute certificate but could vary depending upon the system implementation.

The pre-registration record is encrypted into an S/MIME (Secure/Multipurpose Internet Mail Extensions) envelope using the PKI credentials of the management application. In other words, the management application performs any cryptographic processing that may be required, such as encrypting the data and/or providing a digital signature to be checked eventually by the certificate issuing authority. The S/MIME envelope is attached to e-mail message 404, and management application 400 subsequently sends e-mail message 404 with S/MIME envelope 406 containing pre-registration record 408 to the user using the user's e-mail address as obtained from the directory. In order to create and send e-mail message 404, management application 400 may interoperate with an e-mail application and a security software application that provides PKI functionality.

As part of the new user's training or initial processing, the user is provided with instructions on accessing the e-mail account, including a new identity that forms the basis of the user's e-mail address. User 410 then accesses the e-mail account using an appropriate e-mail client application, such as browser 412.

The following examples use a browser as a preferred application, but other applications, such as a dedicated e-mail application, may be used as long as the client application has the appropriate functionality required to accomplish the present invention. Depending upon the implementation, the client application may have native functionality built into the client application that performs some of the processing indicated as being required by the e-mail message. However, in the preferred embodiment, the client application provides an extensible, modular, runtime environment for accomplishing some of the functionality for the present invention. For example, the description below refers to a browser performing certain tasks, but it should be understood that the browser or client application provides a runtime environment such that the tasks may be accomplished. It may be assumed that the browser understands and interprets scripts and/or applets in cooperation with a script interpreter and/or a virtual machine installed on the client machine to perform some of the tasks. In addition, the browser provides cryptographic key generation functionality and key/digital certificate management functionality, which are common features for browsers.

User 410 views e-mail message 404 through the client application or browser-type application 412. E-mail message 404 has been coded to include user interface functionality. For example, the e-mail message may be formatted as a markup language form with buttons and controls that prompt the user for additional personal or enterprise-specific information, such as passwords for applications within the enterprise. Preferably, e-mail message 404 also contains a script or applet that causes browser 412 to perform additional functions. Pop-up windows may be used to emphasize that the user is completing an important, independent task and that the e-mail message should not be discarded without first completing the entire process that is requested by the e-mail message.

The user operates the browser to enter any requested additional information, such as authentication data 414, which may include passwords to be used with various corporate applications and protected resources. The additional information may eventually be stored as attribute data within an attribute certificate that forms a portion of the user's set of PKI credentials.

The types of information which are requested from the user may be determined by the user information that was retrieved from the directory, such as title or department. The e-mail message may have been created in a static manner such that the e-mail message already includes the necessary fields. Alternatively, the browser may run a script or applet associated with the e-mail message that determines what information to ask the user based on the information within the pre-registration record and based on the information provided by the user while interacting with the e-mail message. For example, passwords can be checked dynamically to ensure that common words or places are not used as a password in a manner that subjects the passwords to a dictionary attack, and the passwords or other information can be checked dynamically to ensure that the user has entered information in a manner that is required by the target applications or protected resources.

At some point, the user enters the requested information or otherwise completes the requested tasks. To ensure that the user has completed the requested processes, a specific button, such as a “Finish” button, could be presented to the user. After the user selects the button, the browser automatically performs the remaining tasks at the client.

The browser generates a public/private key pair and automatically securely stores user private key 416 in secure local keystore 418. Public Key Cryptographic Standard #11 (PKCS #11) defines a standard architecture for cryptographic hardware tokens, such as PCMCIA (Personal Computer Memory Card International Association) cards or smart cards, that enable a high level of data security. A cryptographic hardware token is a hardware repository for secret keys, certificates, one or more cryptographic engines, and a CPU to process the necessary public key-based cryptography functions. PKCS #11 allows any application to support independently-developed smart tokens. If tokens are properly designed, they cannot be copied or made to divulge their secrets, and they can be physically secured by the user just like a wallet, car keys, or other personal valuables. The Public Key Cryptography Standards comprise a suite of specifications defined by a consortium of companies. PKCS enables the development of interoperable applications that use sophisticated public-key encryption, authentication and digital signature techniques to ensure data security. PKCS is a widely implemented and supported public key standard in the world and is compatible with other international standards, including CCITT X.500 and X.509 authenticated directories and certificates.

In other words, without further assistance from management or corporate personnel, the user's private key may be securely stored within a smart card or other physical token that acts as the secure local keystore. A special client application is not required for the client-side processing of the present invention, and the present invention uses only widely available client applications. If the secure local keystore is located on the client machine's hard disk, then the client-side processing of the PKI credential acquisition phase may be completed by a user at any computer that has the required functionality. However, even if a smart card reader and software is required or recommended by the corporate IT department, several commercially products may be available for installation on the client machine.

It should be noted that there may be multiple user keystores on the client device for general security applications and purposes required by the many users that use the client device.

Browser 412 then generates PKI credential request message 420 to be sent to a registration authority or the certificate-issuing authority. The functionality for generating the request may be provided by a plug-in installed with the browser or may be found in an applet or script in the e-mail message. The browser places user-provided authentication information 422, user's public key 424, and pre-registration record 426 into PKI credential request message 420 in the appropriate format. As one example of an acceptable request format, PKCS #10, “Certification Request Syntax”, might be used. Other standards may be used for the protocol by which the requester receives and possibly acknowledges receipt of the PKI credentials after they have been generated.

Browser 412 determines the location of certificate-issuing authority 428 by retrieving a Uniform Resource Identifier (URI), or more specifically, a Uniform Resource Locator (URL), for certificate-issuing authority 428 from the pre-registration record. Browser 412 then sends PKI credential request message 420 to certificate-issuing authority 428 in an appropriate manner, such as a “POST” message using the HTTP or HTTPS protocol.

Certificate-issuing authority 428 then issues PKI credentials 430 for the user. According to the certificate issuance protocol, browser 412 may suspend processing for the user until the PKI credentials are received by the browser. After receipt, browser 412 stores the user's PKI credentials in secure local keystore 418 for the user, such as user public key certificate 432 and user attribute certificate 434 containing encrypted authentication and/or authorization attributes 436.

A copy of the user's credentials are also published into the enterprise's directory in association with the user's other information within directory 402. Depending upon the implementation, certificate-issuing authority 428 is preferably responsible for sending user's PKI credentials 430 to directory server 402, the location of which could be placed into the pre-registration record. Alternatively, the browser sends a copy of the credentials to a directory server prior to terminating its session of acquiring the credentials for the user.

The certificates may then be used in typical manners. For example, other entities may send secure communications to the user by obtaining the user's public key from the user's public key certificate after retrieving the public key certificate from the directory. The user may also present the certificates to the appropriate entities during secure transactions.

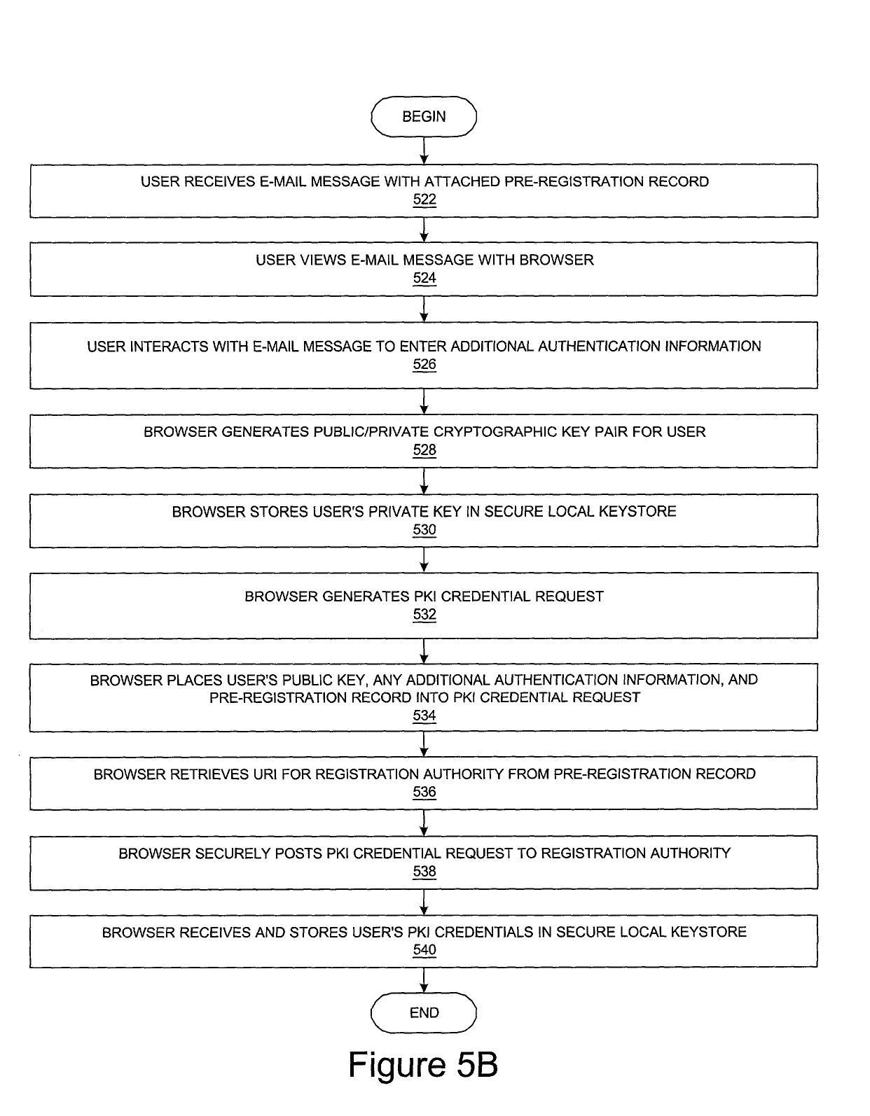

With reference now to FIGS. 5A-5B, a set of flowcharts depicts the processes that are performed by a management application and a user's browser while acquiring and storing the user's PKI credentials in accordance with a preferred embodiment of the present invention. Referring now to FIG. 5A, the process begins when a management application retrieves user information from a directory, such as a corporate directory (step 502). The management application then generates a pre-registration record that is eventually forwarded to a registration authority and stores the user information within the pre-registration record (step 504). The pre-registration record is placed in an e-mail message as an e-mail attachment (step 506) and sent to the user (step 508). After some processing by the user's client application and some interaction with the user, a request is generated for the user's PKI credentials. Eventually, the management application receives and stores the user's PKI credentials in the user's entry within the directory (step 510), and the processing by the management application for acquiring the user's credentials is complete.

Referring now to FIG. 5B, the process begins when the user's client application, such as a browser, receiving the e-mail message with the attached pre-registration record (step 522). The user views the e-mail message (step 524), which may comprise a form or may include some user interface controls for prompting the user to interact with the e-mail message to enter any necessary additional information from the user, such as user authentication information (step 526).

At some point, the user selects a control, such as an “OK” button, that initiates the browser to begin the PKI credential process with respect to a registration authority. The browser generates a public/private cryptographic key pair for the user (step 528) and securely stores the user's private key in a secure local keystore (step 530). The browser then generates a PKI credential request (step 532) and places the user's public key, additional authentication information, and pre-registration record into the PKI credential request (step 534). The browser retrieves the URI for the registration authority from the pre-registration record (step 536) and securely posts the PKI credential request to the registration authority using the URI (step 538). Eventually, a set of PKI credentials is returned to the browser, which stores the user's PKI credentials in the secure local keystore (step 540), and the processing with respect to the end user is complete.

It should be noted that many other common steps, such as verifying the authenticity of a public key certificate, have not been described with respect to FIGS. 4-5B. For example, the certificate issuing authority may verify the authenticity of the pre-registration record prior to issuing the PKI credentials, or the user's browser may verify the authenticity of the e-mail attachment for the pre-registration record. One of ordinary skill in the art would recognize that other processing steps that are common to the processing of digital certificates may be involved and have been omitted for simplicity of presentation.

The advantages of the present invention should be apparent in view of the detailed description of the invention that is provided above. In general, PKI involves the use of protocols, services, and standards supporting applications of public key cryptography, which may involve many entities, including a registration authority and an certification authority. Various services may also be involved: key registration, for issuing a new certificate for a public key; certificate revocation, for canceling a previously issued certificate; key selection, for obtaining an entity's public key; and trust evaluation, for determining whether a certificate is valid and what operations it authorizes. While PKI technology has matured into a robust set of open standards to facilitate secure Internet e-commerce transactions and communications, PKI technology is complex.

Each entity that requires secure transactions and communications actually possesses several PKI-related data items, i.e., credentials, such as keys and certificates, that are required for performing secure transactions and communications. In the prior art, the acquisition of these data items is usually a multi-step process which itself must be performed in a secure manner. After the PKI credentials have been acquired, they must be securely stored and managed to ensure that they are not compromised. Because of the complexity involved in PKI credential acquisition and management, PKI technology has been slowly adopted. Many companies have been formed solely to develop PKI-related software and to help other enterprises adopt PKI technology.

Using the present invention, PKI credentials are securely acquired and stored for subsequent use by users within an enterprise. The methodology provided by the present invention may be integrated into other user enrollment, user initialization, or user configuration management activities. More importantly, the present invention uses existing and common Internet-enabled and PKI-enabled applications such that the methodology of the present invention does not require replacement or major adjustments to an enterprise's installed information technology. In addition, by adhering to open standards, the present invention does not introduce any additional entities or credentials into previously known PKI methods. In other words, the present invention greatly simplifies the acquisition of known PKI credentials from known PKI-related entities or authorities without proposing the addition or modification of PKI standards.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for acquiring public-key infrastructure (PKI) credentials for a user, the method comprising:
generating a pre-registration record for the user;
sending the pre-registration record as an e-mail attachment in an e-mail message to the user at a client;
generating at the client a cryptographic key pair comprising a user private key and a user public key;
sending a PKI credential request for the PKI credentials to a certificate issuing authority, wherein the public key certificate request comprises the pre-registration record and the user public key; and
receiving the PKI credentials at the client.

2. The method of claim 1 further comprising:
retrieving user information from a directory; and
storing the user information into the pre-registration record.

3. The method of claim 1 further comprising:
viewing the e-mail message within a browser, wherein the browser generates the cryptographic key pair; and
storing the user private key in a secure local keystore at the client by the browser.

4. The method of claim 1 wherein the e-mail message is formatted according to an Secure/Multipurpose Internet Mail Extensions (S/MIME) standard.

5. The method of claim 1 further comprising:
prompting the user for user authentication data to be included in an attribute certificate; and
storing the user authentication data in the PKI credential request.

6. The method of claim 1 further comprising:
retrieving a Uniform Resource Identifier (URI) from the e-mail message; and
posting the public key certificate request to the certificate issuing authority using the URI.

7. The method of claim 1 further comprising:
storing the PKI credentials in a secure local keystore at the client.

8. The method of claim 1 wherein the PKI credentials comprise a public key certificate for the user and an attribute certificate for the user.

9. The method of claim 1 further comprising:
publishing the PKI credentials in a directory.

10. The method of claim 1 wherein the PKI credentials are formatted according to an X.509 standard.

11. An apparatus for acquiring public-key infrastructure (PKI) credentials for a user, the apparatus comprising:
means for generating a pre-registration record for the user;
means for sending the pre-registration record as an e-mail attachment in an e-mail message to the user at a client;
means for generating at the client a cryptographic key pair comprising a user private key and a user public key;
means for sending a PKI credential request for the PKI credentials to a certificate issuing authority, wherein the public key certificate request comprises the pre-registration record and the user public key; and
means for receiving the PKI credentials at the client.

12. The apparatus of claim 11 further comprising:
means for retrieving user information from a directory; and
means for storing the user information into the pre-registration record.

13. The apparatus of claim 11 further comprising:
means for viewing the e-mail message within a browser, wherein the browser generates the cryptographic key pair; and
means for storing the user private key in a secure local keystore at the client by the browser.

14. The apparatus of claim 11 wherein the e-mail message is formatted according to an Secure/Multipurpose Internet Mail Extensions (S/MIME) standard.

15. The apparatus of claim 11 further comprising:
means for prompting the user for user authentication data to be included in an attribute certificate; and
means for storing the user authentication data in the PKI credential request.

16. The apparatus of claim 11 further comprising:
means for retrieving a Uniform Resource Identifier (URI) from the e-mail message; and
means for posting the public key certificate request to the certificate issuing authority using the URI.

17. The apparatus of claim 11 further comprising:
means for storing the PKI credentials in a secure local keystore at the client.

18. The apparatus of claim 11 wherein the PKI credentials comprise a public key certificate for the user and an attribute certificate for the user.

19. The apparatus of claim 11 further comprising:
means for publishing the PKI credentials in a directory.

20. The apparatus of claim 11 wherein the PKI credentials are formatted according to an X.509 standard.

21. A computer program product in a computer-readable medium for use in a data processing system for acquiring public-key infrastructure (PKI) credentials for a user, the computer program product comprising:
instructions for generating a pre-registration record for the user;
instructions for sending the pre-registration record as an e-mail attachment in an e-mail message to the user at a client;
instructions for generating at the client a cryptographic key pair comprising a user private key and a user public key;
instructions for sending a PKI credential request for the PKI credentials to a certificate issuing authority, wherein the public key certificate request comprises the pre-registration record and the user public key; and
instructions for receiving the PKI credentials at the client.

22. The computer program product of claim 21 further comprising:
instructions for retrieving user information from a directory; and
instructions for storing the user information into the pre-registration record.

23. The computer program product of claim 21 further comprising:
instructions for viewing the e-mail message within a browser, wherein the browser generates the cryptographic key pair; and
instructions for storing the user private key in a secure local keystore at the client by the browser.

24. The computer program product of claim 21 wherein the e-mail message is formatted according to an Secure/Multipurpose Internet Mail Extensions (S/MIME) standard.

25. The computer program product of claim 21 further comprising:
instructions for prompting the user for user authentication data to be included in an attribute certificate; and
instructions for storing the user authentication data in the PKI credential request.

26. The computer program product of claim 21 further comprising:
instructions for retrieving a Uniform Resource Identifier (URI) from the e-mail message; and
instructions for posting the public key certificate request to the certificate issuing authority using the URI.

27. The computer program product of claim 21 further comprising:
instructions for storing the PKI credentials in a secure local keystore at the client.

28. The computer program product of claim 21 wherein the PKI credentials comprise a public key certificate for the user and an attribute certificate for the user.

29. The computer program product of claim 21 further comprising:
instructions for publishing the PKI credentials in a directory.

30. The computer program product of claim 21 wherein the PKI credentials are formatted according to an X.509 standard.
